(19) United States
(12) Patent Application Publication
(10) Pub. No.: US 2013/0162605 A1
(43) Pub. Date: Jun. 27, 2013

(54) ELECTRONIC PEN

(71) Applicant: FUJI XEROX CO., LTD., Tokyo (JP)

(72) Inventors: Eisuke OSAKABE, Kanagawa (JP); Kazushige OOI, Kanagawa (JP)

(73) Assignee: FUJI XEROX CO., LTD., Tokyo (JP)

(21) Appl. No.: 13/710,851

(22) Filed: Dec. 11, 2012

(30) Foreign Application Priority Data
Dec. 27, 2011 (JP) 2011-285487
Nov. 1, 2012 (JP) 2012-242095

(51) Int. Cl. G06F 3/033

(52) U.S. Cl. CPC G06F 3/033
USPC 345/179

(57) ABSTRACT

An electronic pen includes a housing that is provided with an opening and a guide groove guiding a penholder inserted from the opening side, a holding portion that is fixed to the housing and holds the penholder fitted into the guide groove, and a first circuit board that is fixed to the housing at a position opposite the housing with the guide groove interposed therebetween, and has an imaging device mounted on one board surface thereof to image reflected light from a medium onto which light is irradiated by an irradiation unit irradiating light from the opening onto the medium outside the housing, wherein, in the housing, the portion of the guide groove, a portion where the holding portion is fixed, and a portion where the first circuit board is fixed are formed by a single member.

### CROSS-REFERENCE TO RELATED APPLICATIONS

This application is based on and claims priority under 35 USC 119 from Japanese Patent Application Nos. 2011-285487 filed Dec. 27, 2011 and 2012-242095 filed Nov. 1, 2012.

### BACKGROUND

(i) Technical Field

The present invention relates to an electronic pen.

(ii) Related Art

In general, as reasons for interference with a signal process using the imaging result of the electronic pen, for example, there is the effect of displacement of components due to an external force applied to the housing when the user grips the electronic pen, or accumulation of the tolerance of the components. If the number of places where components are fixed increases so as to suppress displacement of components, the effect of tolerance of components increases or the dimension of the electronic pen increases around the pen point.

### SUMMARY

According to an aspect of the invention, there is provided an electronic pen including a housing that is provided with an opening and a guide groove guiding a penholder inserted from the opening side, a holding portion that is fixed to the housing and holds the penholder fitted into the guide groove, and a first circuit board that is fixed to the housing at a position opposite the housing with the guide groove interposed therebetween, and has an imaging device mounted on one board surface thereof to image reflected light from a medium onto which light is irradiated by an irradiation unit irradiating light from the opening onto the medium outside the housing, wherein, in the housing, the portion of the guide groove, a portion where the holding portion is fixed, and a portion where the first circuit board is fixed are formed by a single member.

### BRIEF DESCRIPTION OF THE DRAWINGS

Exemplary embodiments of the present invention will be described in detail based on the following figures, wherein:

FIG. 1 is a diagram showing the overall configuration of a system;

FIG. 2 is a diagram illustrating the configuration of an encoded image;

FIG. 3 is a block diagram showing the configuration of an electronic pen;

FIGS. 4A and 4B are diagrams showing the configuration of a housing of an electronic pen;

FIGS. 5A and 5B are sectional views of a housing of an electronic pen;

FIGS. 6A and 6B are diagrams showing the configuration of an electronic pen (after a first circuit board and the like are mounted);

FIGS. 7A and 7B are diagrams showing the configuration of an electronic pen (after an imaging device is mounted);

FIGS. 8A and 8B are diagrams showing the configuration of an electronic pen (after a second circuit board and the like are mounted);

FIG. 9 is an enlarged view of an imaging device and a portion around an irradiation unit;

FIG. 10 is a schematic view of a mode in which an electronic pen is viewed from an opening side;

FIG. 11 is an explanatory view of a wiring structure around an imaging device; and

FIGS. 12A and 12B are explanatory views of the content of calibration of an electronic pen.

### DETAILED DESCRIPTION

Hereinafter, an exemplary embodiment of the invention will be described with reference to the drawings.

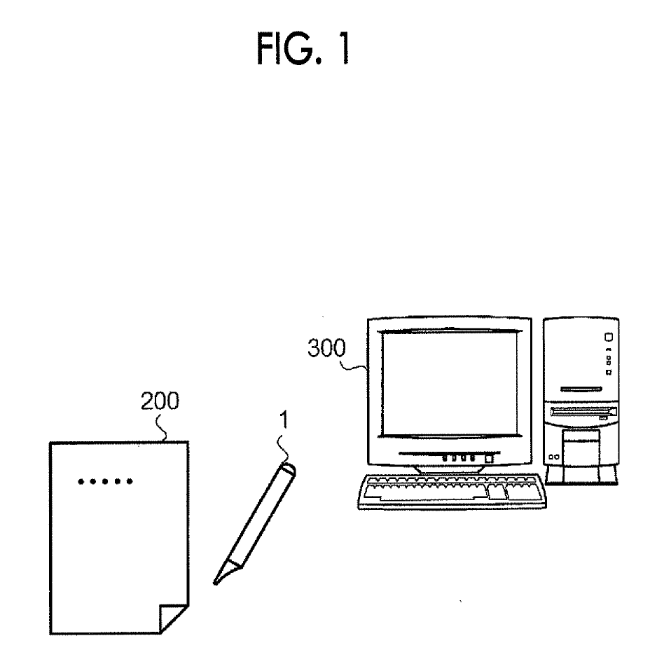

FIG. 1 is a diagram showing the overall configuration of a system of this exemplary embodiment.

The system of this exemplary embodiment is broadly divided into an electronic pen 1, a medium 200, and a PC (Personal Computer) 300. The electronic pen 1 is an example of an electronic pen described in the appended claims, and realizes a function of allowing a user to handwrite letters, figures, or the like on the medium 200 and a function of capturing an encoded image formed on the medium 200. The encoded image formed on the medium 200 is encoded information in accordance with a determined encoding system and imaged. The medium 200 may be paper, plastic, such as an OHP sheet, or other materials, and may be an electronic paper on which the display content is electrically rewritten. If information is decoded from the encoded image at a position specified by the electronic pen 1, the PC 300 performs a process using the decoded information. The PC 300 converts the content handwritten by the user with the electronic pen 1 to an electronic form to generate electronic data representing an electronic document.

Next, the encoded image formed on the medium 200 will be described.

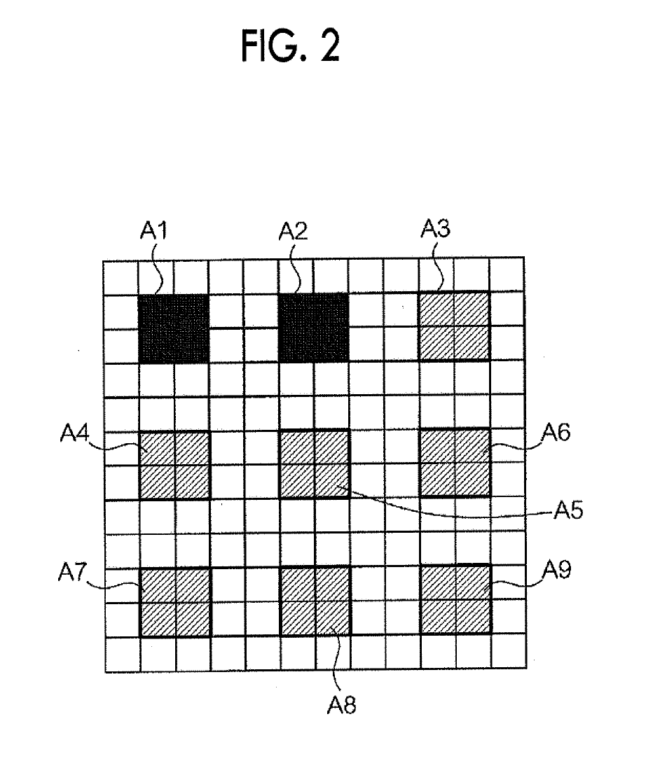

FIG. 2 is a diagram illustrating an encoded image.

As shown in FIG. 2, the encoded image is a set of multiple dot-like images. In FIG. 2, black rectangular regions A1 and A2 correspond to regions where dot-like images are arranged, and hatched regions A3 to A9 correspond to regions where no dot-like images are arranged. The encoded image is an image which represents identification information for identifying the medium 200 or positional information for indicating a position on the medium 200, and information is represented in accordance with the arrangement pattern of dot-like images.

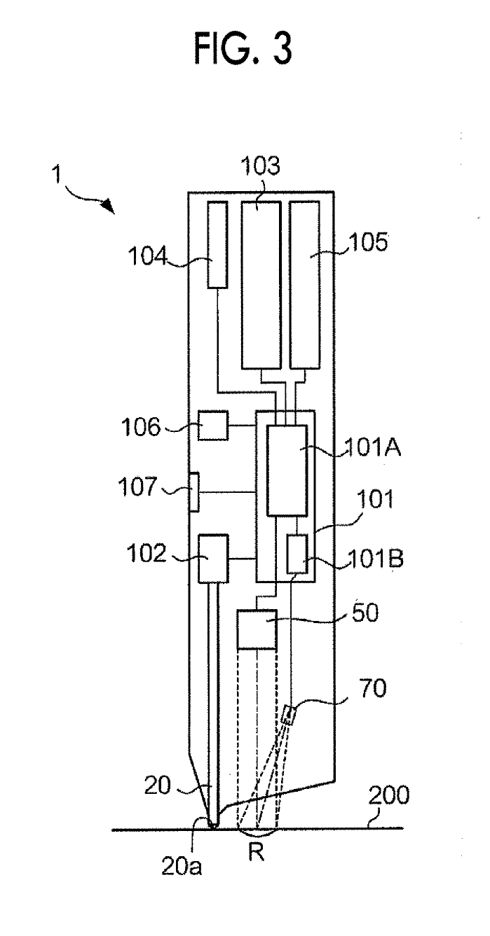

FIG. 3 is a block diagram showing the configuration of the electronic pen 1.

A control unit 101 includes a signal processing circuit 101A and a driving circuit 101B, and also includes a configuration for power management of the electronic pen 1, or the like. The signal processing circuit 101A includes an arithmetic device which includes a CPU (Central Processing Unit) or an ASIC (Application Specific Integrated Circuit), and a memory, and carries out a signal process in the electronic pen 1. For example, the signal processing circuit 101A analyzes a captured image which is an image obtained by imaging the medium 200 to decode information indicated by the encoded image and extracts identification information and positional information. The driving circuit 101B is a circuit which controls the driving of the irradiation unit 70, and controls, for example, the irradiation timing of light (infrared light) by the irradiation unit 70. When a handwriting operation is performed by the user, the driving circuit 101B allows the irradiation unit 70 to irradiate light in an imaging range R on the medium 200 under control based on the detection result of a pressure sensor 102. The pressure sensor 102 detects the handwriting operation by the electronic pen 1 on the basis of a pressure (specifically, writing pressure) applied to a refill 20.

The imaging device 50 images reflected light from the medium 200 of infrared light irradiated from the irradiation unit 70. In the electronic pen 1, the surface of the medium 200 is imaged at a frame rate (for example, 60 fps (frame per second)) set in advance by the imaging device 50. An information memory 103 stores the identification information and the positional information extracted by the signal processing circuit 101A. The communication unit 104 performs control relating to wireless communication between the electronic pen 1 and the PC 300. A battery 105 is, for example, a rechargeable battery, and supplies power for driving the electronic pen 1 to the respective units of the electronic pen 1. A pen ID memory 106 stores the identification information of the electronic pen 1. A switch 107 is used to switch various settings of the electronic pen 1, or the like.

The refill 20 is an example of a penholder described in the appended claims, and is attachable to and detachable from the electronic pen 1. A pen point 20a is provided in the tip portion of the refill 20. When a handwriting operation is performed by the user using the electronic pen 1, the pen point 20a indicates a position on the medium 200 with the encoded image formed thereon, and ejects ink to realize handwriting on the medium 200.

Next, the structure of the electronic pen 1 will be described in detail.

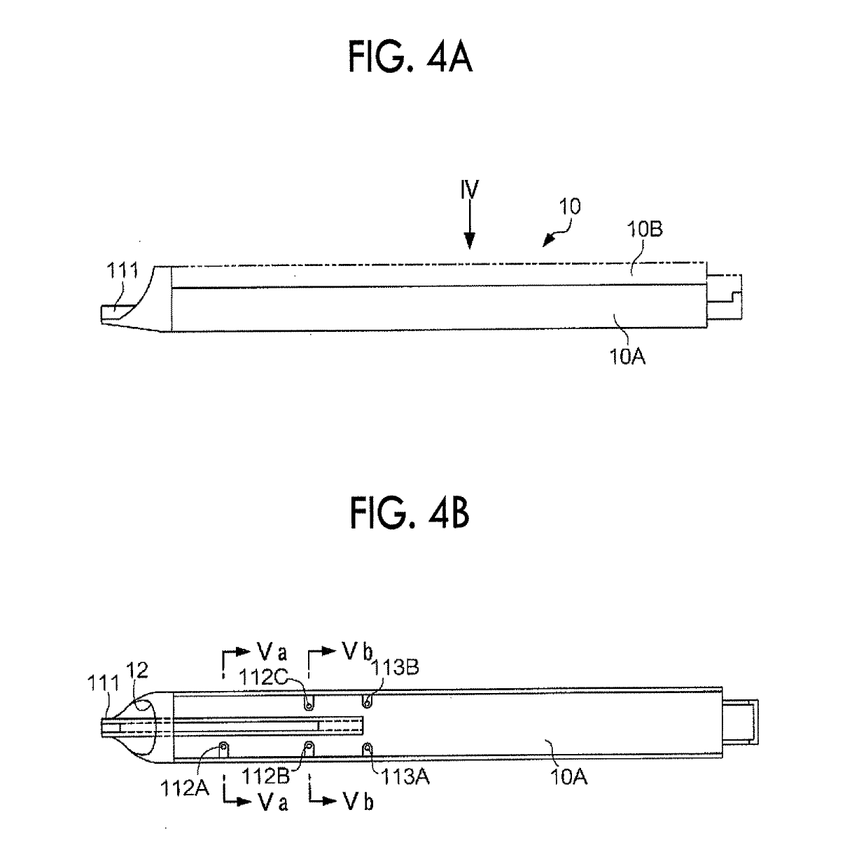

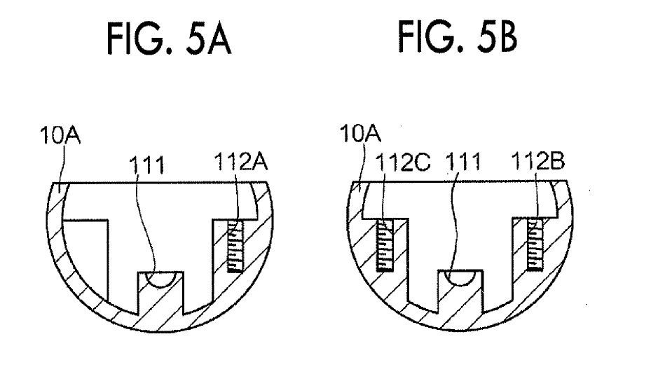

FIGS. 4A and 4B are diagrams showing the appearance of the housing 10 of the electronic pen 1. FIG. 4A is a plan view showing a mode in which the housing 10 is viewed from the side. FIG. 4B is a plan view showing a mode in which the inside of a housing 10A is viewed in an arrow IV direction of FIG. 4A, that is, from the opening side of the housing 10A. FIGS. 5A and 5B are diagrams showing a section when the housing 10A is cut by a plane perpendicular to the longitudinal direction of the electronic pen 1. FIG. 5A is a sectional view showing when the housing 10A is cut at a position corresponding to a boss 112A (a sectional view taken along the line Va-Va of FIG. 4B). FIG. 5B is a sectional view showing when the housing 10A is cut at position corresponding to bosses 112B and 112C (a sectional view taken along the line Vb-Vb of FIG. 4B).

The housing 10 is an example of a housing described in the appended claims, and is an elongated member having a pen shape as a whole in which a housing 10B is mounted in the housing 10A indicated by a solid line at a position indicated by a virtual line. In the housing 10, a columnar internal space in a longitudinal direction is formed, and the components of the electronic pen 1 are accommodated in the internal space. The housing 10A is formed of a single member using a nonmetal material (for example, resin material). In the housing 10A, a ruling pen-shaped opening 12 is formed in a pen point direction which is the left direction in the drawing as one end of the internal space of the housing 10. The opening 12 is opened in the housing 10A to pass through the housing of the electronic pen 1 and to secure the optical path of irradiated light of the irradiation unit 70 or reflected light from the medium 200.

As shown in FIGS. 5A and 5B, each cross-section when the housing 10A is cut by a plane perpendicular to the longitudinal direction of the electronic pen 1 has a “U” shape. In the inner surface of the housing 10A, a refill guide 111, bosses 112A, 112B, and 112C, and bosses 113A and 113C are formed as a single body in the housing 10A.

The refill guide 111 is an example of a guide groove described in the appended claims, and extends along the longitudinal direction of the housing 10A. When the refill 20 is inserted into the housing 10A from the opening 12 side, the refill guide 111 guides the refill 20 in the rear end direction of the electronic pen 1 which is the right direction in the drawing. While the refill guide 111 is formed in a cylindrical shape in the vicinity of the opening 12 and the rear end of the electronic pen 1, as shown in FIGS. 5A and 5B, the cross-section in other portions has a “U” shape and is opened in the same direction as the housing 10A.

The bosses 112A, 112B, and 112C are cylindrical members which form female screws. The boss 112A is provided at a position comparatively close to the opening 12. The bosses 1128 and 1120 are provided to be opposite to each other at positions away from the opening 12 relative to the boss 112A with the refill guide 111 interposed therebetween.

The bosses 113A and 113B are cylindrical members which form female screws. The bosses 113A and 113B are provided to be opposite to each other at positions away from the opening 12 relative to the bosses 112B and 112C with a position on the extension line of the refill guide 111 interposed therebetween.

Next, a configuration in which the refill 20, a first circuit board 30, and a refill holder 40 are provided in the electronic pen 1 shown in FIGS. 4A and 4B will be described.

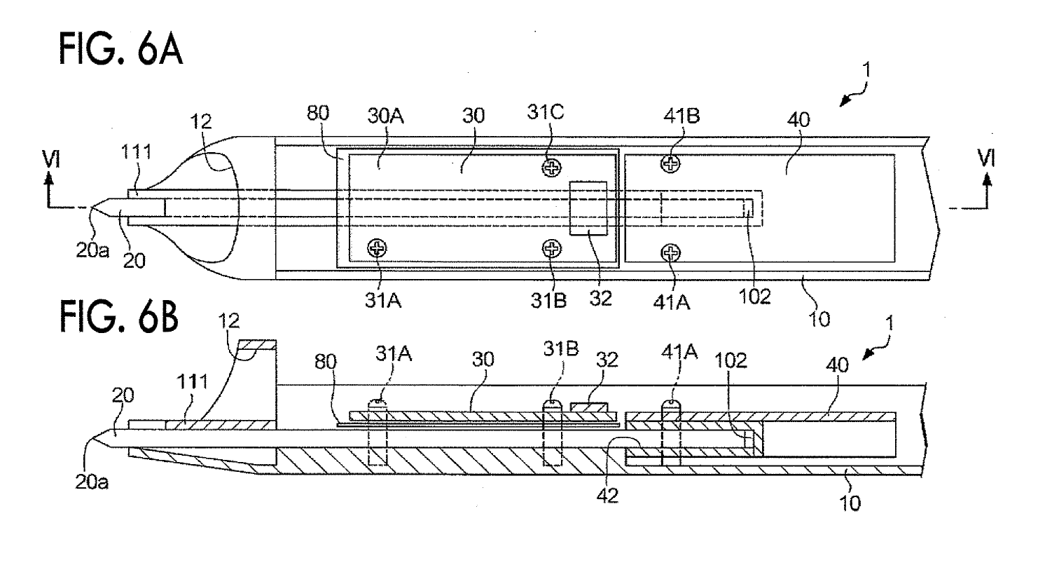

FIGS. 6A and 6B are diagrams showing a configuration in which the refill 20, the first circuit board 30, and the refill holder 40 are provided in the housing 10 shown in FIGS. 4A and 4B. FIG. 6A is a plan view showing a mode in which the housing 10A is viewed in the same direction as in FIG. 5A. FIG. 6B is a sectional view when the electronic pen 1 is cut by a plane along the longitudinal direction of the electronic pen 1 (a sectional view taken along the VI-VI of FIG. 6A). In the following sectional views, for simplification of the drawings, the refill 20 is not hatched.

The refill 20 is formed of a metal, and ink is filled therein. The refill 20 is guided by the refill guide 111 in the rear end direction of the electronic pen 1, and then the rear end portion of the refill 20 is held by the refill holder 40. The refill 20 is fixed in the housing 10A by the refill holder 40 in a state of being fitted to the refill guide 111. At this time, the pen point 20a of the refill 20 is disposed outside the housing 10.

The first circuit board 30 is an example of a first circuit board described in the appended claims. As shown in FIG. 6A, the first circuit board 30 has a rectangular board surface and is, for example, a printed board having a multilayer interconnection structure. The first circuit board 30 is fixed to the housing 10A using fixtures 31A, 31B, and 31C as male screws from a board surface 30A (an example of a first board surface) side. Specifically, the first circuit board 30 is screwed to the boss 112A using the fixture 31A, screwed to the boss 112E using the fixture 31B, and screwed to the boss 112C using the fixture 31C. The fixing of the first circuit board 30 to the housing 10A is carried out using only the three fixtures, and no other fixtures are used. In this way, the first circuit board 30 is screwed near the three corners from among the four corners of the board surface of the first circuit board 30.

A connector 32 is mounted on the board surface 30A of the first circuit board 30. A cable which electrically connects the first circuit board 30 and a second circuit board 60 described below is connected to the connector 32. An interconnection structure around the connector 32 will be described below. Mounting of a component, such as the connector 32, on a circuit board, is realized by, for example, a process for applying a solder onto the board and placing the component.

The refill holder 40 is a member which holds the rear end portion of the refill 20, and an example of a holding portion described in the appended claims. As shown in FIG. 6A, the refill holder 40 is screwed to the boss 113A using a fixture 41A as a male screw and screwed to the boss 113B using a fixture 41B, such that the refill holder 40 is fixed to the housing 10A. The fixing of the refill holder 40 to the housing 10A is carried out using only the two fixtures, and no other fixtures are used. The refill holder 40 has an insertion hole 42 into which the rear end portion of the refill 20 fitted to the refill guide 111 is inserted. If the rear end portion of the refill 20 is inserted into the insertion hole 42 of the refill holder 40, the position of the refill 20 is fixed to the housing 10A. A pressure sensor 102 for detecting a writing pressure of the electronic pen 1 is provided on the innermost side of the insertion hole 42 of the refill holder 40.

As described above, while the refill 20 is formed of a metal, a film-like insulating material 80 is provided at a position where the first circuit board 30 is flush with the refill 20 fitted to the refill guide 111 at a space. The insulating material 80 is provided to prevent the occurrence of electrical failure (for example, short-circuit) in the electronic pen 1 because the refill 20 and the first circuit board 30 are in contact with each other. Since it is sufficient to avoid the refill 20 and the first circuit board 30 from being in contact with each other, the material of the insulating material 80 is not particularly limited.

While the refill guide 111 is formed in a cylindrical shape in the vicinity of both ends, the refill 20 and the first circuit board 30 are not in contact with each other at this position. Accordingly, the insulating material 80 may not be provided at this position.

Next, a configuration in which the imaging device 50 is provided in the electronic pen 1 shown in FIGS. 6A and 6B will be described.

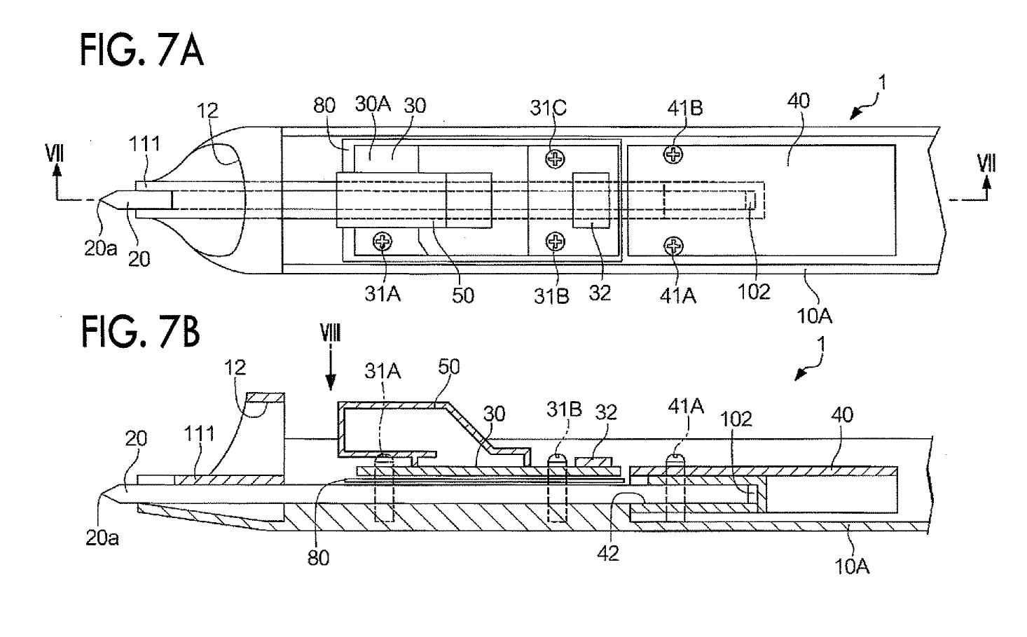

FIGS. 7A and 7B are diagrams showing a configuration in which the imaging device 50 is provided in the electronic pen 1 shown in FIGS. 6A and 6B. FIG. 7A is a plan view showing a mode in which the housing 10A is viewed in the same direction as in FIGS. 5A and 6A. FIG. 7B is a sectional view showing when the electronic pen 1 is cut by a plane along the longitudinal direction of the electronic pen 1 (a sectional view taken along the line VII-VII of FIG. 7A).

The imaging device 50 is mounted on the board surface 30A of the first circuit board 30 by, for example, adhesion. In plan view from the opening side of the housing 10A (hereinafter, referred to as “plan view”), the imaging device 50 is provided at a position not overlapping the fixtures 31A, 31B, and 31B. The imaging device 50 is provided at a position overlapping the refill 20 fitted to the refill guide 111 in plan view, and the dimension in the height direction (the dimension in the direction perpendicular to the paper) is comparatively large in the surrounding portion.

The first circuit board 30 and the imaging device 50 configured as above are manufactured as an optical module in which the imaging device 50 is mounted on the first circuit board 30 in advance, and are then attached to the housing 10A using the fixtures 31A, 31B, and 31C.

Next, a configuration in which the second circuit board 60 and the irradiation unit 70 are provided in the electronic pen 1 shown in FIGS. 7A and 7B will be described.

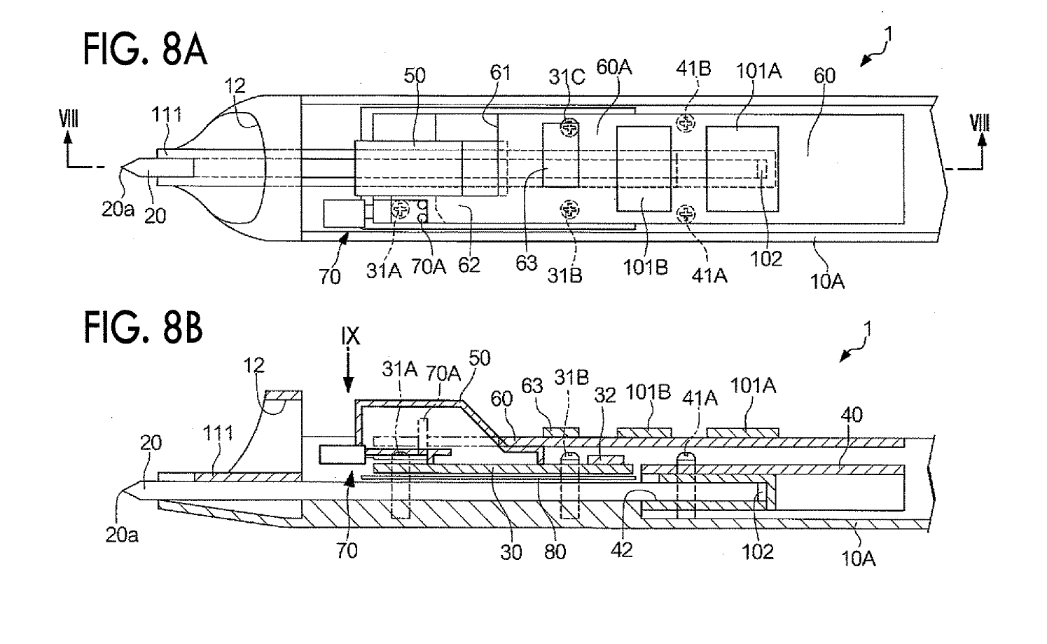

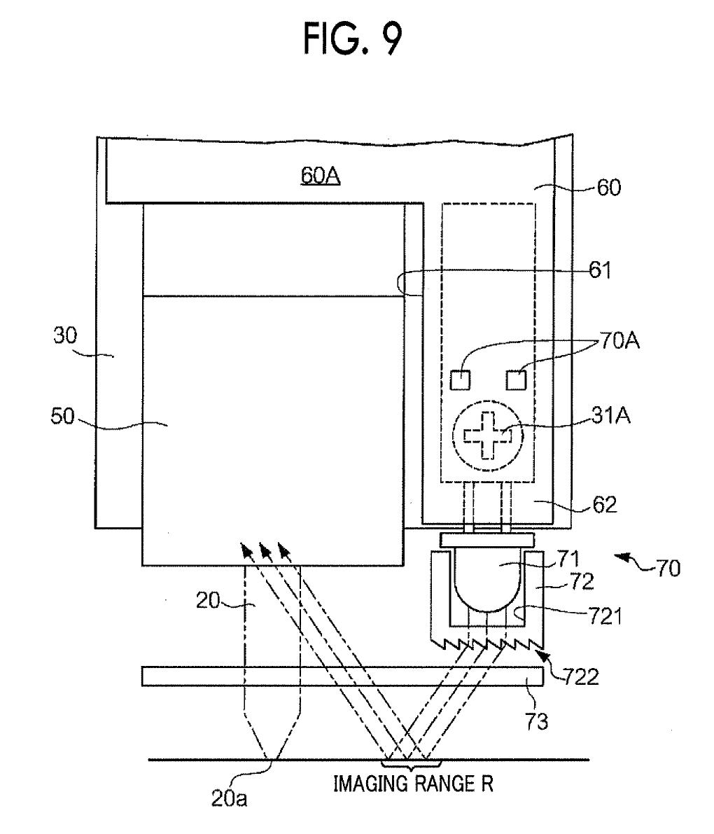

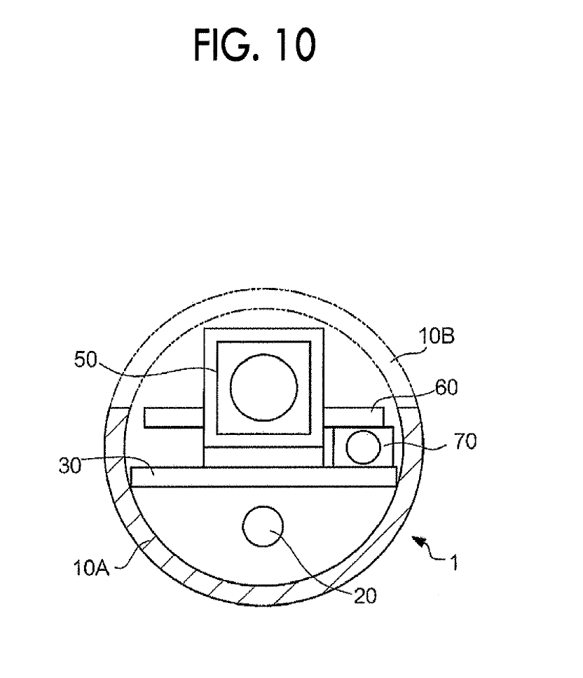

FIGS. 8A and 8B are diagrams showing a configuration in which the second circuit board 60 and the irradiation unit 70 are provided in the electronic pen 1 shown in FIGS. 7A and 7B. FIG. 8A is a plan view showing a mode in which the housing 10A is viewed in the same direction as in FIGS. 5A to 7A. FIG. 8B is a sectional view showing when the electronic pen 1 is cut by a plane along the longitudinal direction of the electronic pen 1 (a sectional view taken along the line VIII-VIII of FIG. 8A). FIG. 9 is an enlarged view of surrounding portions of the imaging device 50 and the irradiation unit 70, and is a diagram showing a mode in which the corresponding portions are viewed from an arrow IX direction of FIGS. 8A and 8B. FIG. 10 is a diagram schematically showing a mode in which the electronic pen 1 is viewed from the opening 12 side.

The second circuit board 60 is an example of a second circuit board described in the appended claims, and is a flexible printed board which is provided apart from the first circuit board 30 to be opposite to the board surface 30A. That is, the second circuit board 60 is flexible, and flexed and deformed in accordance with an external force. The second circuit board 60 has a tip portion 62 with a cutout portion 61 from the pen point 20a (opening 12) side. The cutout portion 61 is formed such that the board surface of the second circuit board 60 has an “L” shape. The imaging device 50 mounted on the first circuit board 30 is inserted into the cutout portion 61, and the imaging device 50 is in contact with the edge of the cutout portion 61. As will be understood from FIG. 10, the cutout portion 61 is formed to secure the arrangement space of the imaging device 50. Accordingly, since the interval between the first circuit board 30 and the second circuit board 60 is smaller than the maximum dimension of the imaging device 50 in the height direction, compared to a case where no cutout portion 61 is formed, an increase in the dimension of the electronic pen 1 relative to the height direction is suppressed. In the second circuit board 60, the irradiation unit 70 is interposed between the tip portion 62 and the first circuit board 30, and mounted in a region of the tip portion 62 on the board surface 30A side. Two protrusions 70A are provided in a surface outside the irradiation unit 70. The two protrusions 70A are fitted into hole portions (not shown) opened in the tip portion 62 of the second circuit board 60, such that the irradiation unit 70 is mounted on the second circuit board 60.

In the second circuit board 60, the signal processing circuit 101A and the driving circuit 101B are provided on a board surface 60A opposite to a board surface 60B arranged opposite the board surface 30A. In this way, in the electronic pen 1, the first circuit board 30 on which the components of the imaging device 50 are mounted is separated from the second circuit board 60 on which no components of the imaging device 50 are mounted.

As shown in FIG. 9, the irradiation unit 70 has a light source 71, a first transmissive member 72, and a second transmissive member 73. The light source 71 is, for example, an LED (Light Emitting Diode), and emits infrared light to irradiate emitted light toward the medium 200. The first transmissive member 72 is an example of a transmissive member described in the appended claims, and diffuses light irradiated from the light source 71 to transmit light outside the housing 10. The first transmissive member 72 has a concave portion 721, in which the light source 71 is disposed, in the surface thereof toward the light source 71. In the first transmissive member 72, a diffusion portion 722 is formed in the surface opposite to the concave portion 721 to have a shape in which multiple triangles are arranged in plan view. The diffusion portion 722 refracts irradiated light of the light source 71 to change the optical path such that emitted light of the light source 71 is irradiated in the imaging range R shown in FIG. 3. With the action of the diffusion portion 722, the direction of irradiated light is changed (indicated by two-dot-chain line arrow), and as a result, the imaging range R is set at a position close to the pen point 20a.

The second transmissive member 73 is provided to be closer to the pen point 20a than the first transmissive member 72. The second transmissive member 73 has a plate shape and functions as a filter which transmits light irradiated by the irradiation unit 70 and blocks light in other wavelength regions. The second transmissive member 73 is provided to suppress imaging of light, such as sunlight, other than irradiated light of the irradiation unit 70 by the imaging device 50, thereby suppressing the effect of disturbance on the imaging result. The second transmissive member 73 is provided at a position through which at least reflected light from the medium 200 passes, and may transmit irradiated light before being irradiated onto the medium 200.

The diffusion portion 722 may be formed in the concave portion 721 of the first transmissive member 72.

A connector 63 is mounted on the board surface 60A of the second circuit board 60. A flexible cable 90 described below for electrically connecting the first circuit board 30 and the second circuit board 60 is connected to the connector 63.

The overall configuration of the electronic pen 1 is as described above. In the electronic pen 1 shown in FIGS. 8A to FIG. 10, if the housing 10B is mounted in the housing 10A, the overall configuration of the electronic pen 1 is completed.

Subsequently, an interconnection structure around the imaging device 50 will be described in detail.

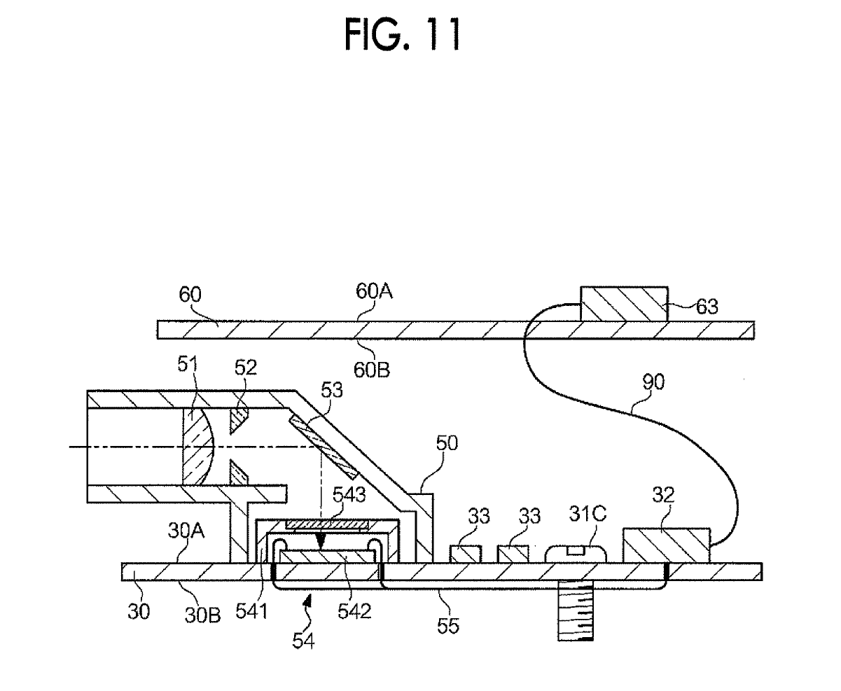

FIG. 11 is a diagram showing a mode in which around the imaging device 50 in the sectional view of FIG. 8B is enlarged, and illustrating an interconnection structure around the imaging device 50. The imaging device 50 has a lens 51, a refining unit 52, a reflector 53, and an imaging unit 54.

As shown in FIG. 11, reflected light (indicated by two-dot-chain line arrow) from the medium 200 in the direction of the pen point 20a corresponding to the left direction in the drawing is incident on the imaging device 50, and reflected light is condensed by the lens 51. Reflected light condensed by the lens 51 is refined by the refining unit 52 and then incident on the reflector 53. The reflector 53 guides incident reflected light toward the imaging unit 54 mounted on the first circuit board 30.

The imaging unit 54 includes an accommodating container 541, a CMOS (Complementary Metal Oxide Semiconductor) sensor 542, and a cover glass 543. The imaging unit 54 has a configuration in which the upper portion of the open accommodating container 541 is covered with the cover glass 543, and the CMOS sensor 542 as an imaging element is packaged. The CMOS sensor 542 is mounted on the board surface 30A of the first circuit board 30 in a wire-bonded manner . The CMOS sensor 542 images reflected light incident from the reflector 53. Through holes are formed in the first circuit board 30 inside the accommodating container 541. The CMOS sensor 542 outputs a signal representing the imaging result to signal lines 55 which are wired along the board surface 30B (an example of a second board surface) opposite to the board surface 30A of the first circuit board 30 through the through holes. The signal lines 55 are interconnection patterns which are arranged on the board surface 30B in a direction away from the opening 12 side (the rear end direction of the electronic pen 1), and are electrically connected to the connector 32. A high-frequency signal in, for example, an LVDS (Low Voltage Differential Signaling) format flows in the signal lines 55.

Electronic components 33 (in this case, passive components) other than components of the imaging device 50 are mounted on the board surface 30A of the first circuit board 30. The electronic components 33 are mounted closer to the pen point (opening 12) than the positions of the fixtures 31B and 31C farthest from the pen point. Therefore, compared to a case where the electronic components 33 are mounted at the rear end from the connector 32, an increase in the dimension of the first circuit board 30 is suppressed, and as a result, an increase in the dimension of the electronic pen 1 is suppressed.

The electronic components 33 are not limited to the electronic components of the imaging device 50, and may be resistive elements, capacitors, inductors, transistors, IC chips, or the like. The electronic components 33 may be provided at positions between the fixture 31B and the fixture 31C. That is, the electronic components 33 are mounted in a region closer to the opening 12 than the fixing position on the rearmost end side (in this case, the rear end positions of the fixtures 31B and 31C) in the longitudinal direction of the electronic pen 1 (that is, the axial direction of the refill 20) from among the fixing position (in this case, the positions of the fixtures 31A, 31B, and 31C) of the first circuit board 30 with respect to the housing 10A. With this configuration, in the electronic pen 1, on the rear end side from the fixing position of the first circuit board 30 with respect to the housing 10A, it is not necessary to secure the region for mounting the electronic components 33 or the region becomes reduced. As a result, an increase in the dimension of the electronic pen 1 in the longitudinal direction is suppressed.

The connector 32 is electrically connected to the connector 63 mounted on the second circuit board 60 using the flexible cable 90. An output signal transmitted from the signal lines 55 to the connector 63 is sent to the connector 63 through the flexible cable 90, and a process based on the output signal is performed in the signal processing circuit 101A.

The structure of the electronic pen 1 is as described above. Next, the content of a process of the signal processing circuit 101A will be described.

The signal processing circuit 101A performs a signal process based on a capture image which represents the imaging result of the imaging device 50. Specifically, the signal processing circuit 101A cuts a partial image including a code pattern image from the captured image, decodes the partial image, and extracts information (that is, coordinate information and identification information) embedded in the code pattern image. The range of the partial image cut from the captured image by the signal processing circuit 101A is set by calibration of the electronic pen 1 in an inspection stage.

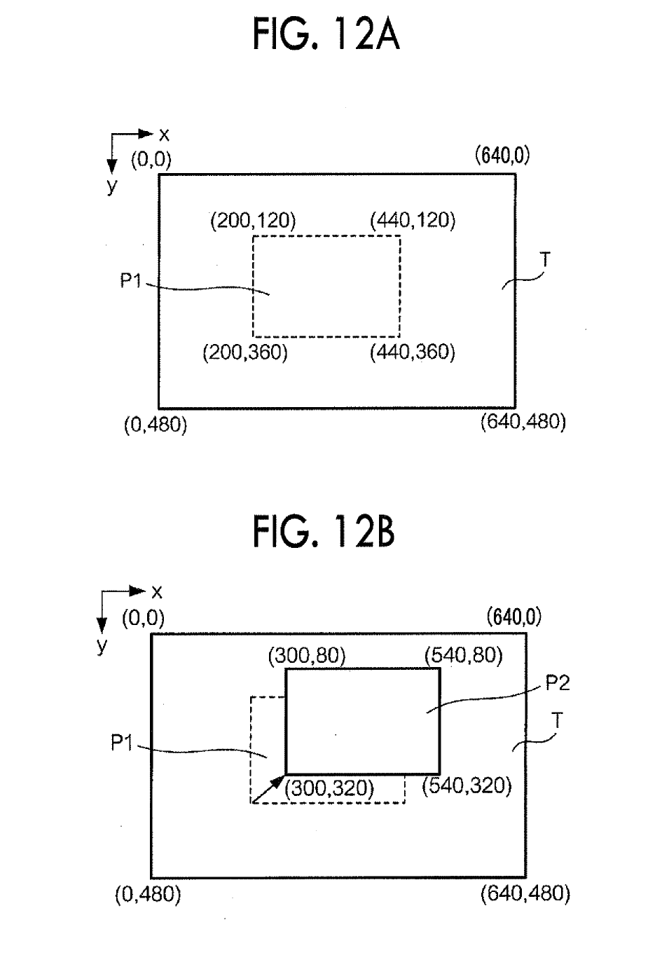

FIGS. 12A and 12B are diagrams illustrating the content of calibration of the electronic pen 1.

In FIGS. 12A and 12B, the xy coordinate system in which the left-right direction of a rectangular image region T of a captured image is referred to as the “x-axis direction” and the up-down direction is referred to as the “y-axis direction” is defined. The xy coordinates are assigned to the pixels with the upper left corner point in the image region T as the origin (0,0). The image region T is a rectangular region of 640 pixels×480 pixels. Meanwhile, the signal processing circuit 101A uses a partial image of 240 pixels×240 pixels to extract the coordinate information and the identification information. In the inspection stage, for example, the electronic pen 1 captures an image for inspection (for example, mark image), and calibration is made such that the image for inspection is displayed at a position (for example, the center of the partial image) set in the partial image. For example, when a shift from the ideal imaging position of the electronic pen 1 is zero, it is assumed that, as shown in FIG. 12A, a rectangular partial image P1 with (x,y)=(200,120), (440,120), (440,360), and (200,360) as four corners is used. When the imaging position of the electronic pen 1 is shifted, as shown in FIG. 12B, calibration of the electronic pen 1 is made such that a rectangular partial image P2 with (x,y)=(300,80), (540,80), (540,320), and (300,320) as four corners is used. When a shift in the imaging position is considerably large, there is a limit to calibration, resulting in interference with a signal process by the signal processing circuit 101A. In contrast, in the electronic pen 1, calibration is easily carried out by the following action. With the calibration of the electronic pen 1, the imaging range R for each electronic pen 1 is uniformized, thereby suppressing the occurrence of an individual difference.

First, in the electronic pen 1, the first circuit board 30 and the second circuit board 60 are separated from each other, an external force (for example, twisting or distortion of the housing 10) which causes changes in the imaging position is prevented from being transmitted to the imaging device 50, and a shift in the imaging position due to the external force is suppressed. Specifically, the light source 71 is disposed in the concave portion 721 of the first transmissive member 72. Accordingly, even if an external force is applied to the light source 71, the displacement of the light source 71 is suppressed by the concave portion 721. When the displacement of the light source 71 is suppressed, this means that the displacement of the tip portion 62 to which the light source 71 is fixed is also suppressed. Therefore, the occurrence of a pressing force of the second circuit board 60 against the imaging device 50 due to the displacement of the second circuit board 60 (tip portion 62) is suppressed, and as a result, the displacement of the imaging device 50 is also suppressed.

Since the refill guide 111, the bosses 112B and 112C, and the bosses 113A and 113B are integrally molded in the housing 10A, there is no effect of tolerance when a member for fixing the first circuit board 30 is separately provided. The first circuit board 30 is fixed to the housing 10A at three places using the fixtures 31A, 31B, and 310. According to this fixing method, changes in the imaging position of the electronic pen 1 are suppressed, and a structure for fixing the first circuit board 30 is prevented from becoming complicated, compared to other methods in which the number of places where components are fixed further increases or components are fixed at different places.

In the electronic pen 1, in addition to the effect of suppressing changes in the imaging position, the following functional effects are obtained.

In the second circuit board 60, a high-frequency signal or a large current flows in the signal processing circuit 101A or the driving circuit 101B, and these circuits become an electrical noise emission source. If the signal lines 55 or the CMOS sensor 542 are provided close to the noise emission source, the signal lines 55 or the CMOS sensor 542 are affected by noise and noise is mixed in the captured image, resulting in interference with encoded image analysis in the signal processing circuit 101A. Meanwhile, if the CMOS sensor 542 is mounted using the through holes, there is little effect of electrical noise from the second circuit board 60 on signals transmitted through the signal lines 55 or an output signal of the CMOS sensor 542. While electrical noise is also generated from the signal lines 55, since the first circuit board 30 is disposed between the signal line 55 and the CMOS sensor 542, the propagation of noise to the CMOS sensor 542 is suppressed by the first circuit board 30.

In the electronic pen 1, a configuration for suppressing a positional shift of the refill 20 or the imaging device 50 is not necessary near the pen point 20a in the vicinity of the opening 12. The first circuit board 30 on which the imaging device 50 is mounted is fixed to the housing 10A using the fixtures 31A, 31B, and 31C, and the refill 20 is configured such that the rear end portion thereof is held by the refill holder 40 fixed to the housing 10A using the fixtures 41A and 418. With this fixing method, since an additional member is not provided in the electronic pen 1 to fix the refill 20 and the imaging device 50, there is no case where the dimension of a portion close to the pen point of the electronic pen 1 increases as much. In the electronic pen 1, even if the refill 20 and the irradiation unit 70 are not aligned with each other due to the first transmissive member 72, the position specified by the pen point 20a approaches the imaging position by the imaging device 50 compared to a case where no first transmissive member 72 is provided.

Since the components of the imaging system are not provided on the second circuit board 60, when mounting components on the second circuit board 60, positional precision as high as the first circuit board 30 is not necessary. In this way, in the second circuit board 60, even if there is a shift in the mounting position of the components, there is little effect on a signal process in the signal processing circuit 101A. In the process for manufacturing the electronic pen 1, high positional precision is not necessary when mounting two circuit boards. Unlike an optical module, since the second circuit board 60 is not adversely affected by dust mixing, the process for manufacturing the electronic pen 1 is simplified compared to a case where high positional precision and dust mixing suppression are necessary when mounting components on both boards.

### MODIFICATIONS

The invention may be carried out in forms different from the foregoing exemplary embodiment. The following modifications may be applied in combination.

In the foregoing exemplary embodiment, the concave portion 721 is formed in the first transmissive member 72, and the light source 71 is disposed in the concave portion 721. Accordingly, even if the light source 71 is displaced due to an external force applied to the housing 10, or the like, the displacement is limited by the first transmissive member 72, thereby improving the positioning precision of the light source 71. Meanwhile, when the displacement of the light source 71 is not problematic, the concave portion 721 may not be provided in the first transmissive member 72. For example, the first transmissive member 72 may have a flat plate shape. When the effect of disturbance or the like is not problematic, the second transmissive member 73 may not be provided. The light source 71 is not limited to a configuration in which the light source 71 is interposed between the tip portion 62 and the first circuit board 30. If the light source 71 is provided in the tip portion 62, the light source 71 may not be interposed between the tip portion 62 and the first circuit board 30.

In the foregoing exemplary embodiment, the first circuit board 30 is fixed to the housing 10A using the fixtures 31A, 31B, and 31B, thereby suppressing changes in the imaging position due to tolerance. Meanwhile, while changes in the imaging position are likely to increase, additional fixtures may be used in the electronic pen 1. The fixtures are not limited to screws, and different fixtures, such as pins or nuts, may be used. Protrusions on the housing 10A side may be inserted into holes formed in the first circuit board 30, such that the first circuit board 30 may be directly fixed to the housing 10A. In this case, it is preferable that the protrusions of the housing 10A are molded integrally with the refill guide 111.

Although in the foregoing exemplary embodiment, the first circuit board 30 is fixed at the three places using the fixtures 31A, 31B, and 31C, the first circuit board 30 may be fixed at four or more places.

Although in the foregoing exemplary embodiment, the electronic components 33 of the first circuit board 30 are mounted closer to the opening 12 than the fixture 31B and the fixture 31C, if an increase in the dimension of the electronic pen 1 in the longitudinal direction is permitted, the electronic components 33 may be mounted closer to the rear end of the electronic pen 1 than the connector 32. The first circuit board 30 may have a configuration in which the electronic components 33 arranged on the board surface 30A are mounted near the imaging device 50. In this case, the electronic components 33 are mounted on the first circuit board 30 using the region where the imaging device 50 is mounted. Accordingly, since it is not necessary to secure the region for mounting the electronic components 33 or the region becomes reduced on the rear end side from the fixing position of the first circuit board 30 with respect to the housing 10A, an increase in the dimension of the electronic pen 1 in the longitudinal direction is suppressed by the region.

Although the connector 63 is mounted on the board surface 60A of the second circuit board 60, the connector 63 may be mounted on the board surface 60B. That is, the second circuit board 60 may be a double-sided mounting board in which the connector 63 or other electronic components are mounted on the board surfaces 60A and 60B. In the case of a single-sided mounting board in which no electronic components are mounted on the board surface 60B of the second circuit board 60, the distance between the second circuit board 60 and the first circuit board 30 is easily reduced, as compared in the case of the double-sided mounting board, and as a result, the electronic pen 1 is easily further thinned.

When the outer peripheral surface of the refill 20 is formed of a nonmetal or when there is no concern that the refill 20 and the first circuit board 30 are in contact with each other, the insulating material 80 may not be provided.

Although the signal lines 55 are arranged (patterned) on the board surface 30B of the first circuit board 30 using the through holes to suppress the effect of noise, if the effect is not problematic, the signal lines 55 may be mounted on the board surface 30A. The signal lines 55 may be arranged inside the first circuit board 30. When the first circuit board 30 is a printed board having a multilayered wiring structure as described above, the signal lines 55 may be arranged on a layer of an inner layer. When the first circuit board 30 is a single-sided mounting board, for example, the distance between the refill 20 and the board surface 30A is easily reduced, and as a result, the electronic pen 1 is easily further thinned. When the first circuit board 30 is a single-sided mounting board, since the center axis of the electronic pen 1 and the beam angle of light guided to the imaging range R (that is, the imaging surface) easily approach a parallel relationship, and the field of view of the electronic pen 1 easily approaches the position of the pen point 20a, the recognition characteristic of the electronic pen 1 hardly depends on the tilting of the electronic pen 1. When the first circuit board 30 is a single-sided mounting board, the position of the pen point 20a easily approaches the center axis of the electronic pen 1.

The board surface of the second circuit board 60 may not be an L shape, and may be cut out in a shape corresponding to the shape of the imaging device 50.

In the electronic pen according to the exemplary embodiment of the invention, the housing and the internal space may not have an elongated shape.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic pen comprising:
a housing that is provided with an opening and a guide groove guiding a penholder inserted from the opening side;
a holding portion that is fixed to the housing and holds the penholder fitted into the guide groove; and
a first circuit board that is fixed to the housing at a position opposite the housing with the guide groove interposed therebetween, and has an imaging device mounted on one board surface thereof to image reflected light from a medium onto which light is irradiated by an irradiation unit irradiating light from the opening onto the medium outside the housing,
wherein, in the housing, the portion of the guide groove, a portion where the holding portion is fixed, and a portion where the first circuit board is fixed are formed by a single member.

2. The electronic pen according to claim 1,
wherein the first circuit board is a single-sided mounting board.

3. The electronic pen according to claim 1, further comprising:
a second circuit board that is provided apart from the first circuit board to be opposite to the one board surface, and has a signal processing circuit mounted thereon performing a process using the imaging result of the imaging device.

4. The electronic pen according to claim 2, further comprising:
a second circuit board that is provided apart from the first circuit board to be opposite to the one board surface, and has a signal processing circuit mounted thereon performing a process using the imaging result of the imaging device.

5. The electronic pen according to claim 3,
wherein no electronic component is mounted on a second board surface of the second circuit board opposite the one board surface.

6. The electronic pen according to claim 4,
wherein no electronic component is mounted on a second board surface of the second circuit board opposite the one board surface.

7. The electronic pen according to claim 3,
wherein the second circuit board has a tip portion that has a cutout portion, into which the imaging device is inserted, on the opening side, and the irradiation unit is mounted in a region of the tip portion on the one board surface, and
the imaging device images reflected light incident from a portion inserted into the cutout portion.

8. The electronic pen according to claim 4,
wherein the second circuit board has a tip portion that has a cutout portion, into which the imaging device is inserted, on the opening side, and the irradiation unit is mounted in a region of the tip portion on the one board surface, and
the imaging device images reflected light incident from a portion inserted into the cutout portion.

9. The electronic pen according to claim 5,
wherein the second circuit board has a tip portion that has a cutout portion, into which the imaging device is inserted, on the opening side, and the irradiation unit is mounted in a region of the tip portion on the one board surface, and
the imaging device images reflected light incident from a portion inserted into the cutout portion.

10. The electronic pen according to claim 6,
wherein the second circuit board has a tip portion that has a cutout portion, into which the imaging device is inserted, on the opening side, and the irradiation unit is mounted in a region of the tip portion on the one board surface, and
the imaging device images reflected light incident from a portion inserted into the cutout portion.

11. The electronic pen according to claim 1,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

12. The electronic pen according to claim 2,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

13. The electronic pen according to claim 3,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

14. The electronic pen according to claim 4,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

15. The electronic pen according to claim 5,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

16. The electronic pen according to claim 6,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

17. The electronic pen according to claim 7,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

18. The electronic pen according to claim 8,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

19. The electronic pen according to claim 9,
wherein a portion corresponding to the guide groove of the housing is formed of a nonmetal,
the penholder includes a metal portion on the outer peripheral surface thereof, and
an insulating material is provided between the first circuit board and the metal portion in the penholder fitted into the guide groove.

20. The electronic pen according to claim 1,
wherein the signal processing circuit cuts out an image region of a portion of an image generated on the basis of an output signal of the imaging device and performs a process based on the content of the cut image region.
